(19) United States
(12) Patent Application Publication
(10) Pub. No.: US 2007/0085976 A1
(43) Pub. Date: Apr. 19, 2007

(54) PROJECTION DEVICE

(76) Inventors: Chien-Yi Yang, Hsinchu (TW); Po-Hsiang Huang, Hsinchu (TW); Cheng-Yang Chen, Hsinchu (TW)

Correspondence Address: NORTH AMERICA INTELLECTUAL PROPERTY CORPORATION, P.O. BOX 506, MERRIFIELD, VA, 22116, US

(21) Appl. No.: 11/530,481

(22) Filed: Sep. 11, 2006

(30) Foreign Application Priority Data
Oct. 19, 2005 (TW) 094136629

(51) Int. Cl. G03B 21/18

(52) U.S. Cl. 353/57

(57) ABSTRACT

A projection device includes a light source for providing a light beam, a light valve device installed on an optical path of the light beam, and a projection lens. The light valve device includes a light valve having an incident surface and a dust-off device. The light beam projects to the incident surface, and the incident surface reflects the light beam to form an image light beam. The dust-off device is installed on the light valve for sealing the incident surface for preventing dust from falling on the light valve. The dust-off device includes a vibrator for removing dust thereon by vibration for preventing dust from affecting the quality of projection images. The projection lens is used for projecting the image light beam out of the projection device.

### BACKGROUND OF THE INVENTION

1. Field of the Invention

The present invention relates to a projection device, and more particularly, to a projection device with a dust-off device.

2. Description of the Prior Art

Please refer to FIG. 1. FIG. 1 is a diagram of a projection device 10 in the prior art. The projection device 10 includes a light source 11, a lens 12, a light valve 13, and a projection lens 14. The light source emits a light beam 111. The lens guides the light beam 111 to project on the light valve 13. The light valve 13 reflects the light beam 111 to form an image light beam 131. The projection lens 14 projects the image light beam 131 out of the projection device 10 to project an image onto a screen (not shown). When the light valve 13 is covered with dust, the quality of the images is reduced because of the dust. The conventional solution is disposing the light valve 13, a side of the lens 12, and an inner side of the projection lens 14 inside a housing 15. The light valve 13 is sealed inside the housing 15 for preventing dust from falling on the light valve 13.

However heat generated by the light beam 111 emitted from the light source 11 is not dissipated easily nearby the lens 12 and the light valve 13 within the housing 15. A fan 16 is disposed inside the housing 15 for dissipating the heat. Unfortunately the convective air caused by the fan 16 takes dust to enter into the housing 15, and the dust pollutes the inner components, such as the light valves 13. It is difficult to sweep the dust when disassembling the housing 15. Furthermore, it must be careful to avoid scraping the costly light valve 13 so as to increase labor hour and risk of sweeping the dust.

### SUMMARY OF THE INVENTION

It is therefore a primary objective of the claimed invention to provide a projection device with a dust-off device to prevent dust from falling on a light valve for solving the above-mentioned problem.

According to the claimed invention, a projection device includes a light source for providing a light beam, and a light valve device installed on an optical path of the light beam. The light valve device includes a light valve including an incident surface. The light beam projects to the incident surface, and the incident surface reflects the light beam to form an image light beam. The light valve device further includes a dust-off device installed on the light valve for sealing the incident surface for preventing dust from falling on the light valve. The dust-off device includes a vibrator for removing dust thereon by vibration for preventing dust from affecting the quality of projection images. The projection device further includes a projection lens for projecting the image light beam out of the projection device.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of a projection device in the prior art.

FIG. 2 is a lateral view of a projection device according to a preferred embodiment of the present invention.

### DETAILED DESCRIPTION

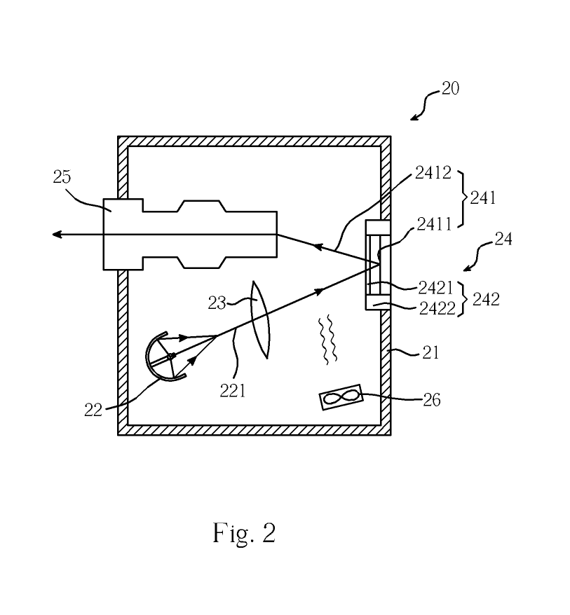

Please refer to FIG. 2. FIG. 2 is a lateral view of a projection device 20 according to a preferred embodiment of the present invention. The projection device 20 includes a housing 21, a light source 22 installed inside the housing 21, a lens 23, a light valve device 24, and a projection lens 25. The light source 22 generates a light beam 221. The light source is a high pressure mercury bulb, a metal halide lamp, a xenon lamp, and so on. The lens 23 is made of glass, PNMA, PC, or other plastic material. The lens 23 is installed on an optical path of the light beam 221 for guiding the light beam 221 emitted from the light source 22 to project on the light valve device 24.

The light valve device 24 is installed on the optical path of the light beam 221 and on a side of the lens 23 opposite to the light source 22. The light valve device 24 includes a light valve 241 and a dust-off device 242. The light valve 241 includes an incident surface 2411. The light beam 221 projects to the incident surface 2411, and the incident surface 2411 reflects the light beam 221 to form an image light beam 2412. The light valve 241 is a digital micromirror device, Liquid-Crystal-on-Silicon (LCOS), and so on. The dust-off device 242 is installed on the light valve 241 for sealing the incident surface 2411 so as to prevent dust from falling on the incident surface 2411. The dust-off device 242 includes a transparent filter 2421 and a vibrator 2422 for removing dust on the filter 2421 by vibration of the vibrator 2422. The filter 2421 is installed between the incident surface 2411 and the projection lens 25. The light beam 221 penetrates the filter 2421 to project on the light valve device 24. The filter 2421 is made of glass, plastic material, or other transparent material so that the light beam 221 penetrates the filter 2421. The vibration frequency of the vibrator 2422 is a vibration frequency of a supersonic wave or 20000 Hz approximately. The vibrator 2422 is a supersonic generator for vibrating the filter 2421 at the vibration frequency of the supersonic wave about 20,000 Hz so as to remove dust on the filter 2421. The projection lens 25 projects the image light beam 2412 reflected from the light valve device 24 out of the projection device 20 onto a screen (not shown). The focus of the image light beam 2412 is adjusted so as to project an image on the screen clearly.

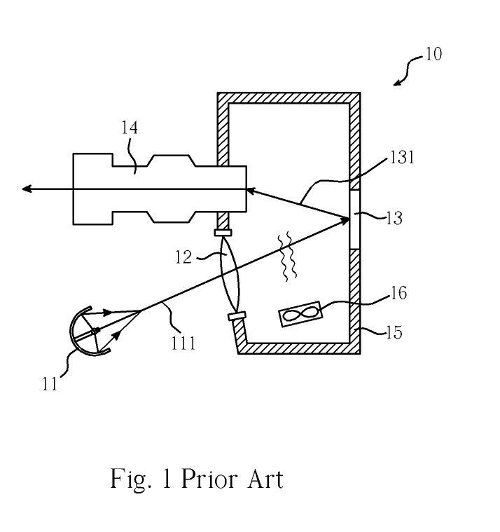

Because the dust-off device 242 is installed on the light valve 241 for sealing the incident surface 2411, the dust falls on the filter 2421 of the dust-off device 242 instead of falling on the light valve 241 so as to prevent the dust from polluting the light valve 241. In addition, the vibrator 2422 of the dust-off device 242 vibrates at a high speed so as to dust down the filter 2421 for preventing the dust from affecting the quality of projection images. Referring to FIGS. 1 and 2, in contrast to the conventional housing 15 for shielding the light valve 13, the dust-off device 242 according to the present invention not only blocks dust from the light valve 241 but also sweeps the dust on the filter 2421 by the vibration of the vibrator 2422 quickly. The light valve 241 and the lens 23 are not disposed inside a close housing so that it is helpful for heat dissipation due to large heat-dissipating space.

A fan 26 is installed inside the projection device 20 for convecting air inside the projection device 20 so as to cool inner components within the projection device 20, such as the light source 22, the light valve 2421, and so on. In addition, the projection device 20 further includes a circuit board (not shown) electrically connected to the dust-off device 242 for controlling the dust-off device 242. For example, the circuit board controls the dust-off device 242 to operate the dust-off function after the projection device 20 is turned on and before the light source 22 is activated.

In contrast to the conventional projection device, the projection device according to the present invention utilizes the vibrator to sweep dust on the filter by vibration for preventing the dust from affecting the quality of projection images. Furthermore, the dust-off function is operated after the projection device is turned on every time so as to simplify the clean process of the projection device.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A projection device comprising:
a light source for providing a light beam;
a light valve device installed on an optical path of the light beam, the light valve device comprising:
a light valve comprising an incident surface, the light beam projecting to the incident surface and the incident surface reflecting the light beam to form an image light beam; and
a dust-off device installed on the light valve for sealing the incident surface, the dust-off device comprising a vibrator for removing dust thereon by vibration; and
a projection lens for projecting the image light beam out of the projection device.

2. The projection device of claim 1 further comprising a lens installed between the light source and the light valve device for guiding the light beam to project on the light valve device.

3. The projection device of claim 1, wherein the dust-off device further comprises a filter installed between the incident surface and the projection lens, the light beam penetrating the filter to project on the light valve device.

4. The projection device of claim 1, wherein the dust-off device further comprises a circuit board electrically connected to the vibrator.

5. The projection device of claim 1, wherein the light valve is a digital micromirror device.

6. The projection device of claim 1 wherein the vibrator is a supersonic generator.
